(19) United States
(12) Patent Application Publication
(10) Pub. No.: US 2006/0224651 A1
(43) Pub. Date: Oct. 5, 2006

(54) Combined IFFT and FFT system

(75) Inventors: Srinadh Madhavapeddi, Dallas, TX (US); Manish Goel, Plano, TX (US); Henry N. Angulo, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/095,275

(22) Filed: Mar. 31, 2005

(51) Int. Cl. G06F 17/14

(52) U.S. Cl. 708/404

(57) ABSTRACT

A system (12) for determining discrete transforms as between time and frequency domains. The system comprises a grid (60) comprising adders and multipliers. The grid is operable to perform in parallel an integer number P operations of a first transform function selected from one of either an IFFT or an FFT. The system also comprises the integer number of P serially-operating pipelines (64₁-64₈). Each of the pipelines is coupled to the grid and is operable to perform serially over a number of cycles an integer number S operations of the first transform. In the system, S and P are both greater than one and, in combination, the grid and the serially-operating pipelines perform the first transform type as an S×P-point transform. In a first instance at least a portion of the grid is operable to perform IFFT operations. In a second instance at least a portion of the grid is operable to perform FFT operations.

### CROSS-REFERENCES TO RELATED APPLICATION

Not Applicable.

### STATEMENT REGARDING FEDERALLY SPONSORED RESEARCH OR DEVELOPMENT

Not Applicable.

### BACKGROUND OF THE INVENTION

The present embodiments relate to digital signal processing and are more specifically directed to a combined inverse fast Fourier transform (“IFFT”) and fast Fourier transform (“FFT”) circuit.

Various contemporary digital signal processing circuits and systems require the implementation of IFFT and FFT functionality. For example, orthogonal frequency division multiplexing (“OFDM”) is a multi-carrier frequency system, that is, one where a signal of data bits is sampled into different signals, encoded, and each encoded sample is assigned to a respective sub-carrier frequency; a sample may be of a size selected by one skilled in the art, and by way of example each sample may be one bit wide. Each of the sub-carriers is orthogonal to the others and communicates its respective data signals simultaneously in time with the other carriers. The signal processing in an OFDM transceiver typically includes IFFT and FFT functionality. As another example, contemporary Digital Subscriber Line (“DSL”) modems also implement IFFT and FFT functionality. Still other examples will be ascertainable by one skilled in the art. In various of these applications, IFFT and FFT functions have been implemented by various approaches that are known in the prior art. In general, the IFFT and FFT perform discrete approximations of an inverse Fourier transform and a Fourier transform, respectively. The discrete operations are often performed using a combination of multipliers and adders, so as to perform the known IFFT and FFT equations. One approach for either IFFT or FFT in a Radix 2 implementation is fully serial in nature, that is, for an N-sample transformed output, the serial device operates on one input sample and then combines to provide a result of two samples, and then it combines to provide a result of four samples, continuing in this pattern each time by a power of two until the N-sample output is reached. Another approach for either IFFT or FFT is fully parallel in nature, that is, for an N-sample output, N/2 parallel units each operate on two samples (i.e., two “point”) concurrently to provide a cumulative N-sample result.

While the preceding approaches have proven workable in various prior art implementations, they also may provide various drawbacks, particularly looking to future design criteria. Specifically, in IFFT and FFT circuits, as well as in other signal processing, various criteria are often established for the system design. Such criteria may include considerations of device size, complexity, cost, and speed. A system design must thus efficiently consider such criteria. In this regard, as N in the N-sample output increases, both the fully serial and fully parallel transform approaches have associated drawbacks. For example, in the fully serial implementation, as device speed requirements increase (e.g., in the GHz or higher range), it may not be feasible to provide circuitry, such as multipliers and flip flops, that are capable of operating at such speeds to timely perform the transform. As another example, in the fully parallel operation, such an approach is very gate intensive and, therefore, increases the device size, complexity, and cost. Given these drawbacks as well as others that may be ascertained by one skilled in the art, there arises a need to address the drawbacks of the prior art, as is achieved by the preferred embodiments described below.

### BRIEF SUMMARY OF THE INVENTION

In one preferred embodiment, there is a system for determining discrete transforms as between time and frequency domains. The system comprises a grid comprising adders and multipliers. The grid is operable to perform in parallel an integer number P operations of a first transform function selected from one of either an IFFT or an FFT. The system also comprises the integer number of P serially-operating pipelines. Each of the pipelines is coupled to the grid and is operable to perform serially over a number of cycles an integer number S operations of the first transform. In the system, S and P are both greater than one and, in combination, the grid and the serially-operating pipelines perform the first transform type as an S×P-point transform. In a first instance at least a portion of the grid is operable to perform IFFT operations. In a second instance at least a portion of the grid is operable to perform FFT operations.

Other aspects are also disclosed and claimed.

### BRIEF DESCRIPTION OF THE SEVERAL VIEWS OF THE DRAWING

FIG. 1 illustrates a functional block diagram of a wireless communications transceiver in which the preferred embodiments may operate.

FIG. 2 illustrates a block diagram of IFFT and FFT integrated block 12 of FIG. 1 in greater detail.

FIG. 3 illustrates parallel IFFT block 60 from FIG. 2 in greater detail.

FIG. 4 illustrates some of the eight 32-point IFFT pipeline blocks 64₁ through 64₈ of FIG. 2, in greater detail.

FIG. 5 illustrates integrated block 12 of FIG. 2, with a few modifications to illustrate aspects to perform an FFT with that device.

### DETAILED DESCRIPTION OF THE INVENTION

The preferred embodiments are described as implemented into a digital signal processing integrated circuit in an orthogonal frequency division multiplexing (“OFDM”) transceiver system utilizing that circuit. However, it is contemplated that this invention may have benefit in applications other than the specific implementation described in this specification. Accordingly, it is to be understood that the following description is provided by way of example only and is not intended to limit the inventive scope.

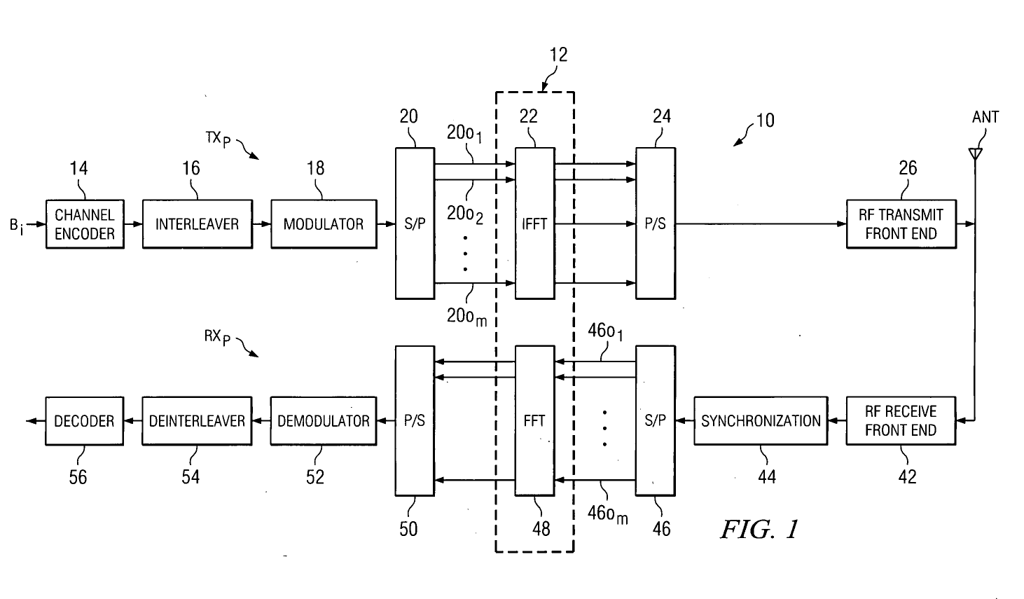

FIG. 1 illustrates a functional block diagram of a wireless communications transceiver 10 by way of a contemporary orthogonal frequency division multiplexing (“OFDM”) example in which the preferred embodiments may operate. By way of introduction to system 10 and OFDM, the more general frequency division multiplexing (“FDM”) is characterized by transmission of multiple signals simultaneously over a single transmission path, such as a wireless system. Each of the multiple signals travels at a different frequency band, sometimes referred to as a carrier or sub-carrier and which is modulated by the data. The data carried by each sub-carrier may be user data of many forms, including text, voice, video, and the like. In addition, the data includes control data. In any event, OFDM was developed several years ago, and it adds an element of orthogonality to FDM. In OFDM, the center frequency of each of the sub-carriers is spaced apart at specific frequencies, where the frequency spacing is such that each sub-carrier is orthogonal to the other sub-carriers. As a result of the orthogonality, ideally each receiving element tuned to a given sub-carrier does not perceive any of the signals communicated at any other of the sub-carriers. Given this aspect, various benefits arise. For example, OFDM is able to use overlapping (while orthogonal) sub-carriers and, as a result, thorough use is made of the overall OFDM spectrum As another example, in many wireless systems, the same transmitted signal arrives at the receiver at different times, that is, having traveled different lengths due to reflections in the channel between the transmitter and receiver; each different arrival of the same originally-transmitted signal is typically referred to as a multipath. Typically multipaths interfere with one another, which is sometimes referred to as intersymbol interference (“ISI”) because each path includes transmitted data referred to as symbols. Nonetheless, the orthogonality implemented by OFDM considerably reduces ISI and, as a result, often a less complex receiver structure, such as one without an equalizer, may be implemented in an OFDM system. Lastly, note that OFDM also has been used in mobile wireless communications and is currently being developed in various respects including in combination with other wireless communication techniques.

Looking now at transceiver 10 in particular, it includes a transmitter path TX_{P} and a receiver path RX_{P}, where both paths in general are known in the art. However, included with these paths is an inverse fast Fourier transform (“IFFT”) and fast Fourier transform (“FFT”) integrated block 12, which is improved per the preferred embodiments and, therefore, also improves the overall transceiver 10. These various improvements are explored later in this document, but prior to reaching that discussion, below is provided a discussion of transmitter path TX_{P} and a receiver path RX_{P} so as to appreciate the overall construction and operation of transceiver 10.

Turning to transmitter path TX_{P} of transceiver 10, it receives information bits Bᵢ from various sources. Bits Bᵢ may be provided by various known types of circuitry and those bits include both user data (e.g., voice, text, or other user-created data) as well as control data. Bits Bᵢ are input to a channel encoder 14. Channel encoder 14 encodes the information bits Bᵢ in an effort to improve raw bit error rate, where various encoding techniques may be used. Preferably, therefore, channel encoder 14 performs forward error correction (“FEC”). Channel encoder 14 also may be changed to use a different coding scheme such as in a Turbo encoder. The encoded output of channel encoder 14 is coupled to the input of an interleaver 16. Interleaver 16 operates with respect to a block of encoded bits and shuffles the ordering of those bits so that the combination of this operation with the encoding by channel encoder 14 exploits the time diversity of the information. For example, one shuffling technique that may be performed by interleaver 16 is to receive bits in a matrix fashion such that bits are received into a matrix in a row-by-row fashion, and then those bits are output from the matrix to a modulator 18 in a column-by-column fashion. As a result, if the SNR of certain bits during transmission falls in level, then when those bits are de-interleaved at the receiver the drop in signal is effectively applied to bits spread at different locations in the data stream rather than concentrated at one location which would thereby render data at that location less discernable. Modulator 18 is in effect a symbol mapper in that it converts its input bits to complex symbols, each designated generally as sᵢ. The converted symbols may take various forms, such as quadrature phase shift keying (“QPSK”) symbols, binary phase shift keying (“BPSK”) symbols, or quadrature amplitude modulation (“QAM”) symbols. Note that modulator 18 might operate differently with respect to the user data and the control data and it may operate on the bits with respect to certain modulation parameters. Each symbol sᵢ is coupled to a serial-to-parallel converter 20. In response, serial-to-parallel converter 20 receives the incoming symbols and outputs m symbols in a parallel stream, along its outputs 20o₁ through 20oₘ, to an inverse fast Fourier transform (“IFFT”) block 22, which is shown as part of integrated block 12. IFFT block 22, as its name suggests, performs an IFFT on samples of the parallel input data, thereby converting the frequency components in the carrier of the signal to the time domain. In the preferred embodiment and as detailed later, a cyclic prefix is also added by block 22. The data in its form as output by IFFT block 22 is referred to in the art as an OFDM symbol, which is not to be confused with each complex symbol sᵢ that is provided by modulator 18; indeed, the art also uses other terms for the OFDM symbol such as a burst. For the sake of consistency, in this document the term OFDM symbol is used, and the OFDM symbol as output from IFFT block 22 is connected to a parallel-to-serial converter 24. Parallel-to-serial converter 24 converts its parallel input to a serial output. Thus, the OFDM symbol is now a serial stream of information, and that stream is connected to a radio frequency (“RF”) transmit front end 26, which includes a digital-to-analog converter as well as other analog RF front-end circuitry. The digital-to-analog converter portion converts the digital input to an analog output, and the analog signal is conditioned and passed to an antenna ANT for transmission to a receiver or another transceiver of the form 10 shown in FIG. 1.

Turning to receiver path RX_{P} in FIG. 1, it receives a transmission such as from another transceiver of the form of transceiver 10, at antenna ANT, and the corresponding electrical signal is connected to an RF receive front end 42. Front end 42 includes an analog-to-digital converter as well as other well-known analog RF receive front-end circuitry. The analog-to-digital converter portion converts the analog input to a digital output, and the digital signal is connected to a synchronization block 44. Synchronization block 44 identifies training tones as they appear in certain OFDM symbols so as to synchronize the receiver with respect to the alignment of the received symbols. Once synchronization block 44 identifies the location of each OFDM symbol, the result is passed to a serial-to-parallel converter 46. Serial-to-parallel converter 46 converts its serial input to a parallel output, where the number m of outputs 46o₁ through 46oₘ corresponds to the same number of m parallel outputs provided by serial-to-parallel converter 20 of the transmit path of the transceiver that communicated the signal. These m outputs from serial-to-parallel converter 48 are connected to a fast Fourier transform (“FFT”) block 50 of integrated block 12. As its name suggests, FFT block 50 performs an FFT on the parallel input data, thereby reversing the effect imposed on the information by the IFFT block (e.g., 20) of the transceiver that communicated the signal. As a result, the output of FFT block 50 provides a parallel set of complex symbols which, assuming proper operation, correspond to and thus are the same as (or are estimates of) the complex symbols provided by the modulator (e.g., 18) of the transmitting device. The output of FFT block 50 is connected to a demodulator 52, which removes the modulation imposed on the signal by the transmitting device. In other words, therefore, whatever type of symbol mapping was implemented by the modulator of the transmitting device, then demodulator 52 performs in effect an inverse of that operation to return the digital bit data. The output of demodulator 52 is connected to a deinterleaver 54. Deinterleaver 54 performs an inverse of the function of the interleaver (e.g., 16) of the transmitting device, and the output of deinterleaver 54 is connected to a channel decoder 56. Channel decoder 56 further decodes the data received at its input, typically operating with respect to certain error correcting codes, and it also may perform these operations in part in response to modulation parameters received from the transmitting device. Channel decoder 56 outputs a resulting stream of decoded data. Finally, the decoded data output by channel decoder 56 may be received and processed by additional circuitry in transceiver 10, although such circuitry is not shown in FIG. 1 so as to simplify the illustration and discussion.

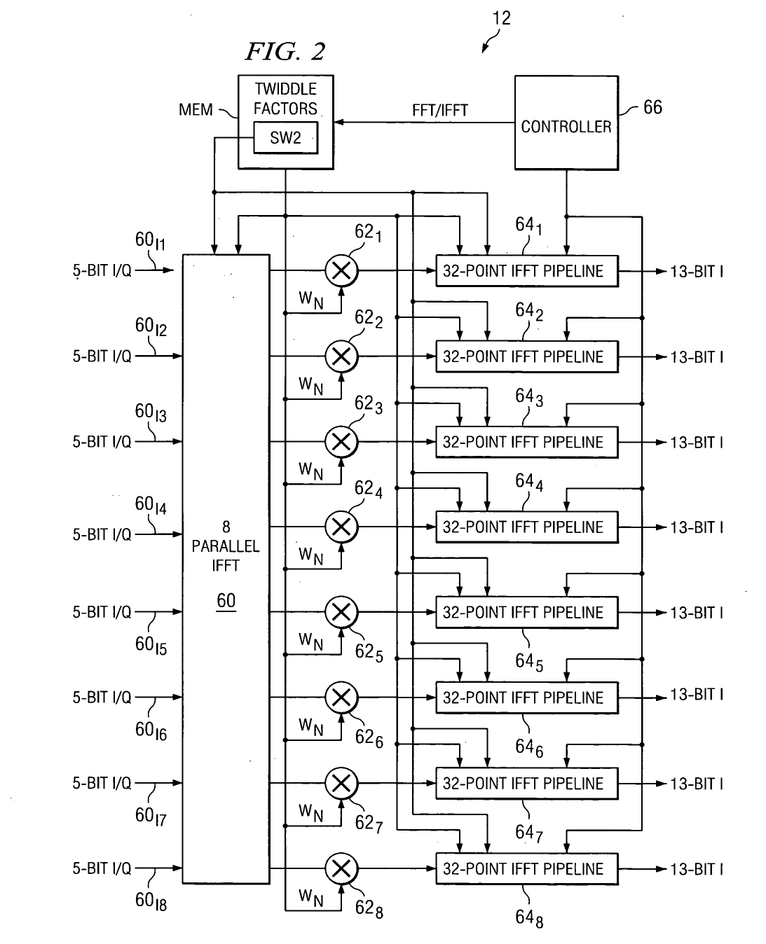

FIG. 2 illustrates a block diagram of IFFT and FFT integrated block 12 of FIG. 1 in greater detail, with still additional elaboration provided through the remainder of this document. In a preferred embodiment, block 12 is devised to receive a complex number input and apply either a 256-point IFFT (i.e., N=256) or a 128-point FFT (i.e., N=128), that is, the same block in general may perform one or the other operation during a given time period. By way of example, FIG. 2 first illustrates connectivity for the IFFT operations and with the instance for each input of a 5-bit complex number (i.e., 5-bit Real and 5-bit Imaginary coefficients) that is conjugate symmetric, so the ultimate output is a Real number. Also by way of introduction, the IFFT operations cumulatively serve the following known Equation 1:

$$IFFT : x [ n ] = \frac{1}{N} {\sum }_{k = 0}^{N - 1} X [ k ] {W}_{N}^{- kn} \qquad Equation 1$$

where, W_{N}, known in the art as a Twiddle factor, is as shown in the following Equation 2:
W_{N}=e^{-j2π/N} Equation 2
Given the preceding, as shown below, block 12 includes both a parallel component and a number of serial (i.e., “pipeline”) components to achieve the operation of Equation 1.

Looking now to block 12 of FIG. 2 in greater detail, at one time a total of eight 5-bit complex numbers, representing complex frequency samples, are input to a parallel IFFT block 60, along respective inputs 60_{I1} through 60_{I8}. As detailed later, parallel IFFT block 60 includes a grid that performs, in parallel, an eight point IFFT operation in response to these eight inputs and over three stages of operation. In response, eight 8-bit results are output, with each of the eight outputs connected as a multiplicand input to one of respective multipliers 62₁ through 62⁸. Each multiplier 62ₓ also receives as a second multiplicand a corresponding Twiddle factor, W_{N}. Although every connection is not expressly shown, note that these instances of illustrated Twiddle factors as well as those throughout the remainder of the document (unless stated otherwise) are preferably provided to the appropriate circuit by addressing a memory MEM, such as a read only memory (“ROM”), that stores a collection of the desired Twiddle factors for output to the appropriate locations within the circuit. Moreover, while the Twiddle factors are shown as W_{N}, one skilled in the art should appreciate that such factor also may be represented as W_{N}^{lq} in that the factor changes based on its position within the illustration as well as the timing of the sample, such that N=256 and 0≦l≦31 and 0q≦7. For example, for a first set of eight samples that are received in parallel to the respective multipliers 62₁ through 62₈ then l=0, while q=0 for multiplier 62₁, q=1 for multiplier 62₂, q=2 for multiplier 62₃, and so on incrementally upward to q=7 for multiplier 62₈, and for a second set of eight samples that are received in parallel to the respective multipliers 62₁ through 62₈, then l=1, while q=0 for multiplier 62₁, q=1 for multiplier 62₂, q=2 for multiplier 62₃, and so on incrementally upward to q=7 for multiplier 62₈. This pattern repeats as q applies in the same manner for all other sets of samples, but while l increases by one for each of those sample sets until all 32 sets are processed for a total of N=256 samples, after which l returns to a value of 0 and this pattern repeats. With this understanding, the output of each of the eight multipliers 62ₓ is connected as an input to a respective one of eight 32-point IFFT pipeline blocks 64ₓ. As detailed later, each 32-point IFFT pipeline bock 64ₓ is operable to perform a 32-point serial IFFT operation. The output of each 32-point IFFT pipeline block 64ₓ provides a 13-bit Real number, representing the IFFT of one sample. Moreover, a controller 66 controls each of blocks 64ₓ so as to provide synchronized operation and, therefore, collectively all IFFT blocks 64₁ through 64₈ at a same time provide a total of eight 13-bit IFFT samples. Accordingly, in a total of 32 output operations of all of blocks 64ₓ, then a 256-point (i.e., 8 samples/cycle*32 cycles=256 samples) IFFT is performed. Moreover and as detailed later, the operation of each block 64ₓ is through a total of five stages, with each stage adding a bit of resolution and, hence, each output of a block 64ₓ provides a 13-bit result.

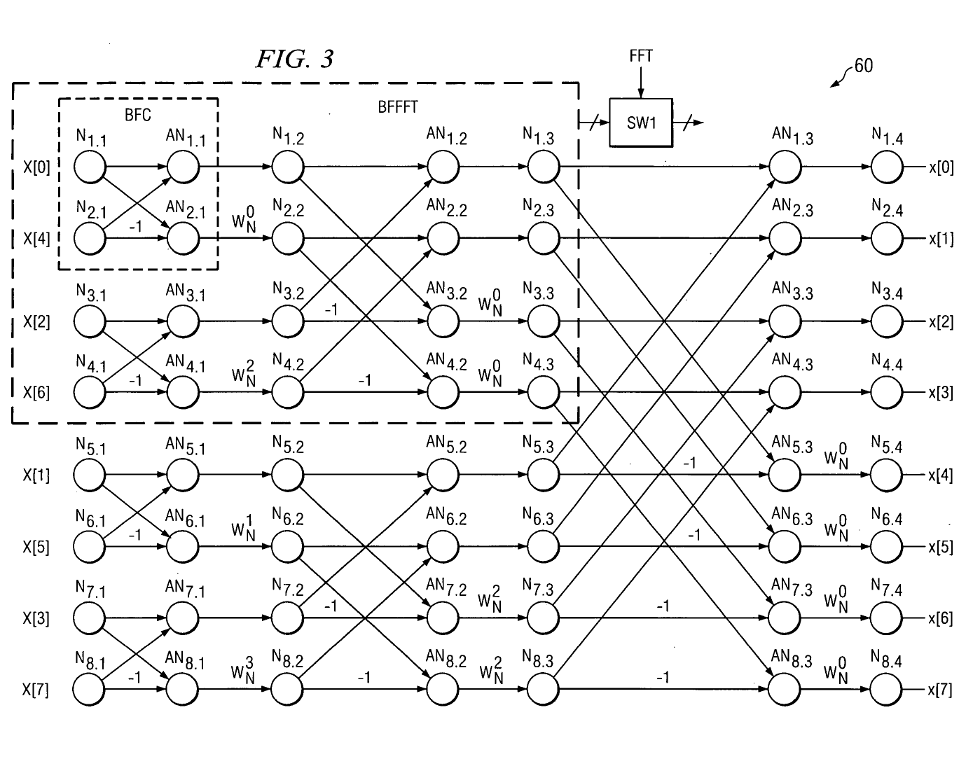

FIG. 3 illustrates parallel IFFT block 60 from FIG. 2 in greater detail. In general, block 60 provides a parallel IFFT function and, standing alone, the configuration of FIG. 3 is know in the art; however, in forming block 60 and combining that with parallel pipelines as shown in FIG. 2 and also in using a subset of the circuit to provide an FFT function, the preferred embodiments are formed. Looking then to FIG. 3 in greater detail, eight parallel frequency input signal samples are shown as X[0] through X[7]. Note that these values are not linearly aligned, but instead they are input out of linear order by indexing each sample in a preferred manner so as to assure a particular corresponding output. Particularly, the out-of-order of frequency samples shown to the left of FIG. 3 results in a corresponding set of linear ordered time samples shown to the right of FIG. 3, as x[0] through x[7], and it also accommodates a prefix functionality described later. By way of introduction, the connectivity through the grid in FIG. 3 demonstrates functionally both multiplication and addition as a signal is traced through the grid; thus, in implementation, various combinations of hardware and software may be implemented to achieve this functionality, as is ascertainable by one skilled in the art given the specific connectivity, as further discussed below.

The connectivity of block 60 is now described by way of tracing various examples through its illustrated grid. Looking to sample X[0] as a first example, it is connected from a node N_{1.1} as an addend to an adder node AN_{1.1}, which also receives sample X[4] as an addend from a node N₂₁. The sum of these two samples is coupled to a node N_{1.2}, from where that sum is connected as an addend input to an adder node AN_{1.2}, which also receives an addend input from a node N_{3.2}. The output of adder node AN_{1.2} is connected to a node N_{1.3}, from where it is provided as an addend input to adder node AN_{1.3} and also to an adder node AN_{5.3}. Adder node AN_{1.3} receives as a second addend input the value from a node N_{5.3}, and the sum determined by adder node AN_{1.3} is connected to a node N_{1.4}, which provides the transformed sample value, x[0]. Looking to sample X[4] as another example, it illustrates additional connectivity, and certain signals also are shown to incur a multiplication times either a −1 or a Twiddle factor, as is now explored. Sample X[4] is connected from a node N_{2.1} as an addend input to adder node AN_{1.1}; additionally, sample X[4] is multiplied times −1 and the product is connected as an addend input to adder node AN_{2.1}, which also receives sample X[0] as an addend input from node N_{1.1}. At this point, therefore, note that the connectivity depicted as horizontal and diagonal with respect to samples X[0] and X[4] and adder nodes AN_{1.1} and AN_{2.1} is referred to in the art as a butterfly connection or butterfly circuit, where such connection is identified by way of example in FIG. 3 within a dotted box designated BFC. Such connectivity is useful to note as it pertains to a later discussion as well. Continuing with respect to the connectivity flowing from sample X[4], the sum from adder node AN_{2.1} is multiplied times the Twiddle factor, W_{N}⁰, and the product is connected to a node N_{2.2}. As noted earlier, this Twiddle factor as well as the others in FIG. 3 are preferably provided by addressing a memory store MEM that stores the various Twiddle factors for a given value of k and N. From node N_{2.2}, the provided product is connected as an addend to adder node AN_{2.2}, which also receives a value from a node N_{4.2}; node N_{2.2} is also connected as an addend input to adder node AN_{4.2}. The sum output of adder node AN_{2.2} is connected to a node N_{2.3}, which connects that sum as an addend input to an adder node AN_{2.3} and also as an addend input to an adder node AN_{6.3}. Adder node AN_{2.3} also receives as an addend from node N_{6.3}, and the sum from adder node AN_{2.3} is connected to node N_{2.4}, which provides the transformed sample, x[1].

From the preceding and with the skill in the art, one should appreciate the overall operation of block 60 of FIG. 3. In general, each frequency sample X[z] is added and multiplied in various instances, where three additions are incurred for each trace across the grid and where each horizontal trace represents an accumulation that is affected by various samples as represented by the diagonal traces that add into each horizontal trace. As a result, for each five-bit frequency sample X[z], an eight-bit time sample x[t] is produced. Moreover, the eight horizontal traces demonstrate that an eight point IFFT is performed in parallel for the input samples. Referring back to FIG. 2, therefore, each resulting sample is then coupled to a corresponding multiplier 62ₓ, where it is multiplied times another Twiddle factor, with the product passed to a respective 32-point IFFT pipeline, where each such pipeline is further discussed below.

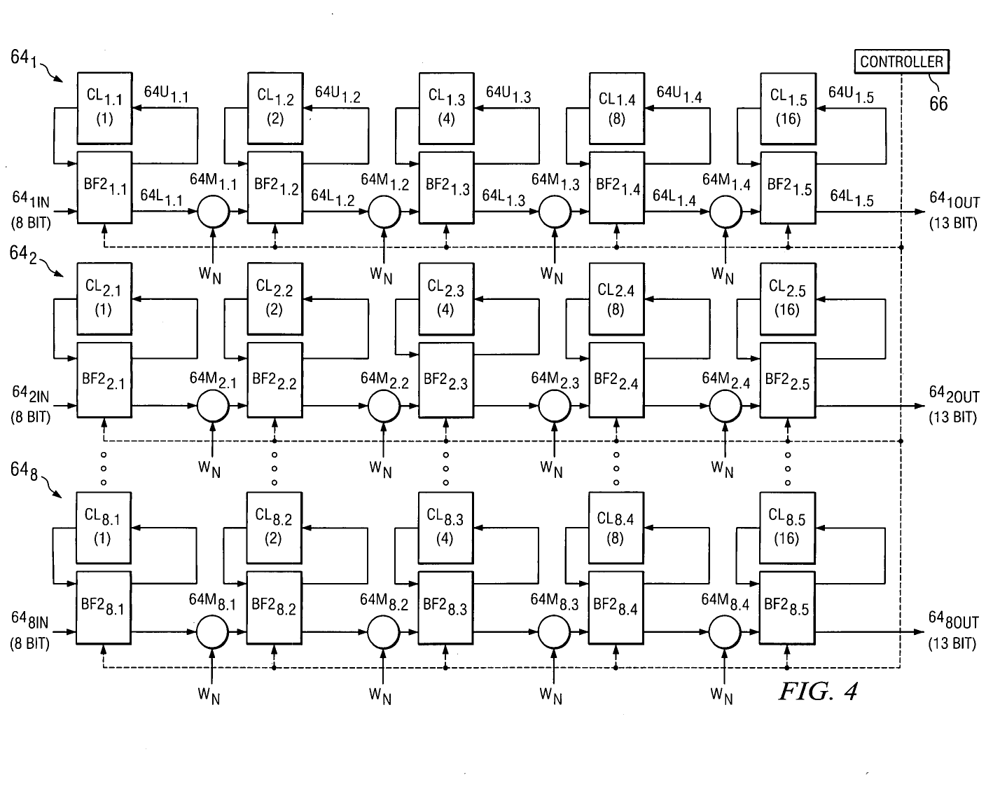

FIG. 4 illustrates some of the eight 32-point IFFT pipeline blocks 64₁ through 64₈ of FIG. 2, in greater detail, with an understanding that those specific blocks 64₃ through 64₇ that are not shown are removed from the drawing solely for simplicity, with such blocks having the same construction as those illustrated and now described. In general, the configuration of any individual pipeline of FIG. 4 is known in the art; however, in selecting the number and dimensions of each pipeline and combining that with parallel IFFT block 60 as shown in FIG. 2 and permitting one of either IFFT or FFT operations during a given time period, the preferred embodiments are formed. Looking then to FIG. 4 in greater detail, each individual pipeline block 64ₓ provides a serial IFFT function independent of each other pipeline block, receiving an 8-bit complex value at its input 64_{xIN} and, through five stages, producing a 13-bit Real value at its output 64_{xouT}. Note that the Real value output occurs due to the conjugate symmetry of the 256 sample input to the system applied in groups of 8 parallel samples at the input of block 60. Moreover, the common controller 66 ensures synchronization (as shown by dashed lines in FIG. 4) of each pipeline block so as to provide concurrent timing of the output of each pipeline block, thereby providing a total of eight outputs, one from each respective pipeline block, at a time. Looking now to the details of pipeline block 64₁ by way of example, input 64_{1IN} is connected to a butterfly circuit BF2_{1.1}. Recall the connectivity of such a butterfly circuit was introduced above with respect to butterfly circuit BFC in FIG. 3. In FIG. 4, however, a second input to butterfly circuit BF2_{1.1} is from a sample collection circuit CL_{1.1}, which collects from the upper output 64U_{1.1} of butterfly circuit BF2_{1.1}, only one sample, with that one sample represented by the “1” in parenthesis adjacent the “CL_{1.1}” designation in FIG. 4. Thus, in a first cycle of operation, butterfly circuit BF2_{1.1} provides outputs at both its upper and lower outputs 64U_{1.1} and 64_{1.1}, respectively, with the signal at upper output 64U_{1.1} being collected by collection circuit CL_{1.1}; in the next clock cycle, butterfly circuit BF2_{1.1} receives a next sample from input 64_{1IN}, and at the same time it receives as a second input from collection circuit CL1.1 the sample collected one clock cycle earlier by collection circuit CL_{1.1}. In response, the signal at lower output 64L_{1.1} is connected as a multiplicand input to a multiplier 64M_{1.1}, which receives a Twiddle factor as its second multiplicand input. The output of multiplier 64M_{1.1} is connected as a first input to the next stage butterfly circuit BF2_{1.2}.

Looking to butterfly circuit BF2_{1.2} in additional detail, a second input to butterfly circuit BF2_{1.2} is from a sample collection circuit CL_{1.2}, which collects over successive clock cycles two samples from the upper output 64U_{1.2} of butterfly circuit BF2_{1.2}, with those two samples represented by the “2” in parenthesis adjacent the CL_{1.2} designation. Thus, in a first initial cycle of operation, butterfly circuit BF2_{1.2} provides outputs at both its upper and lower outputs 64U_{1.2} and 64L_{1.2}, respectively, with the signal at upper output 64U_{1.2} being collected by collection circuit CL_{1.2}; in a second clock cycle, butterfly circuit BF2_{1.2} receives a next sample from input 64_{1IN}, but in this second clock cycle, a second input is not yet available from collection circuit CL_{1.2}. However, in a third clock cycle, butterfly circuit BF2_{1.1} receives yet another sample from input 64_{1IN}, and at this same time with two samples having been collected by collection circuit CL_{1.2}, the first of those two samples, collected two clock cycles earlier, is now provided by that circuit as a second input to butterfly circuit BF2_{1.2}, and in response an output is connected as a multiplicand input to a multiplier 64M_{1.2}, which receives a Twiddle factor as its second multiplicand input. This process repeats, so that in a fourth clock cycle, butterfly circuit BF2_{1.2} receives yet another sample from multiplier 64M_{1.1} and at this same time it receives as an input another sample from collection circuit CL_{1.2} that was collected by collection circuit CL_{1.2} two clock cycles earlier. Accordingly, once two samples are collected by collection circuit CL_{1.2}, for each successive clock cycle it provides an input to butterfly circuit BF2_{1.2} that was output by that same circuit two clock cycles earlier.

The preceding connectivity described with respect to butterfly circuits BF2_{1.1} and BF2_{1.2} is comparable for each of the three remaining three stages of butterfly circuits in pipeline 64₁, with the difference being the number of samples buffered by each collection circuit CL_{1.3}, CL_{1.4}, and CL_{1.5}, which buffer a total of 4, 8, and 16 samples, respectively. Thus: (i) for every clock cycle after four initial clock cycles, collection circuit CL_{1.3} provides as an input to butterfly circuit BF2_{1.3} a sample that was provided from upper output 64U_{1.3} four clock cycles earlier; (ii) for every clock cycle after eight initial clock cycles, collection circuit CL_{1.4} provides as an input to butterfly circuit BF2_{1.4} a sample that was provided from upper output 64U_{1.4} eight clock cycles earlier; and (iii) for every clock cycle after sixteen initial clock cycles, collection circuit CL_{1.5} provides as an input to butterfly circuit BF2_{1.5} a sample that was provided from upper output 64U_{1.5} sixteen clock cycles earlier. Moreover, given this description for pipeline 64₁ and the numbering conventions in FIG. 4, one skilled in the art should appreciate the comparable operation for each of the five stages in the remaining pipelines 64₂ through 64₈. Accordingly, for each pipeline, a total of 31 clock cycles are required for a sample at input 64_{xIN} to generate a corresponding IFFT output signal at output 64_{xOUT}.

Having described various IFFT aspects of the preferred embodiments, recall that block 12 is stated earlier to provide both IFFT and FFT functionality. More particularly, while the preceding has demonstrated a 256-point IFFT, further aspects are now described wherein the preferred embodiments also achieve a 128-point FFT. By way of introduction, first re-stated here is Equation 1, which recall pertains to IFFT operations:

$$IFFT : x [ n ] = \frac{1}{N} {\sum }_{k = 0}^{N - 1} X [ k ] {W}_{N}^{- kn} \qquad Equation 1$$

Next, by way of comparison, consider that FFT operations cumulatively serve the following known Equation 3:

$$FFT : X [ k ] = {\sum }_{k = 0}^{N - 1} x [ n ] {W}_{N}^{- kn} \qquad Equation 3$$

Comparing Equations 1 and 3, note the following differences: (1) IFFT pertains to frequency samples, while FFT pertains to time samples; (2) the sign of the Twiddle factor exponent is negative for IFFT and positive for FFT; and (3) IFFT involves a scaling of 1/N that is not included in FFT. These differences may be implemented as part of the preferred embodiments such that selected functionality and hardware (e.g., multipliers, adders) of the above-described system also may achieve a 128 point FFT, as is further explored below.

Turning first to the change in input/output for the FFT approach to the preferred embodiments, recall from above that IFFT operates with respect to frequency samples and FFT operates with respect to time samples. Accordingly, per the preferred embodiments, to achieve an FFT operation, time samples x(n) are provided as inputs to parallel IFFT block 60. In this regard, however, note various observations. First, since only a 128-point FFT is desired as opposed to the above-achieved 256-point IFFT, then only half of the inputs are used to implement the FFT functionality. Accordingly, time samples are connected only to inputs 60_{I1}, 60_{I2}, 60_{I3}, and 60_{I4}. In addition, recall from FIG. 3 that the architecture for IFFT receives out-of-linear-order frequency inputs to provide linear-order time outputs. In opposite fashion, therefore, when utilizing inputs 60_{I1}, 60_{I2}, 60_{I3}, and 60_{I4} for time sample inputs, then such samples are provided in linear order, with the expectation that the FFT output will be out of linear order. Additionally, because only 128 points are desired, then to provide a four parallel block, only the butterfly circuits BFFFT shown within a dashed box in FIG. 3 are required, that is, for the reduced-size FFT operation (as compared to the IFFT), the four inputs are provided through those circuits BFFFT and the outputs are taken from nodes N_{1.3}, N_{2.3}, N_{3.3}, and N_{4.3}. These outputs are provided, respectively, to pipeline blocks 64₁, 64₃, 64₅, and 64₇ of FIG. 2 (and FIG. 4), by way of multiplexer or switching circuitry SW1 that is enabled when the present operation is an FFT operation, or approaches for this functionally may be ascertained by one skilled in the art. In any event and returning to FIG. 2, therefore, for an FFT operation, pipeline blocks 64₂, 64₄, 64₆, and 64₈ are not used, as may be achieved in various fashions, such as inputting zeroes to those pipelines and/or ignoring their respective outputs. Lastly, given that the FFT will produce time-reversed outputs due to the linear-order inputs, then in the preferred embodiment a buffer (illustrated later) is provided to receive the outputs of pipeline blocks 64₁, 64₃, 64₅, and 64₇ from which the FFT outputs may be then taken in linear order, if desired.

Looking now to the change in sign of the Twiddle factors as between the IFFT and FFT operations, note that both the butterfly circuits BFFFT as well as pipeline blocks 64₁, 64₃, 64₅, and 64₇ require multiplication operations using various Twiddle factors. However, the underlying Twiddle factor other than the exponent sign change remains the same. Accordingly, in the preferred embodiment, the same circuit store (e.g., MEM) that provides the IFFT Twiddle factors may again be addressed to provide those values as the FFT Twiddle factors, with the additional consideration that those factors for the FFT have a change in exponent sign. To accomplish an equivalent of the multiplication times the Twiddle factor with a change in its exponent sign, recall that each sample is a complex number; as a result, then a product from the sample times a Twiddle factor that has a sign change in its exponent may be achieved by swapping the Real and Imaginary coefficients of the input sample and then swapping the Real and Imaginary coefficients of the resulting product output. In other words, for a sample of a+jb times a first Twiddle factor, then the product of that same sample times a second Twiddle factor, which is the first Twiddle factor with a sign change in its exponent, may be achieved by multiplying b+ja times the first Twiddle factor and then switching the Real and Imaginary portions of the product result. Because the IFFT with one sign for its Twiddle factors is applied across the grid of parallel IFFT block 60 and pipelines 64₁ through 64₈, and the FFT with an opposite sign for its Twiddle factors is applied across a portion of the grid of parallel IFFT block 60 and some of pipelines 64₁ through 64₈ as detailed below, then the coefficient swap in the preferred embodiment is only performed at the inputs to block 60 and to the outputs of pipelines 64₁ through 64₈. Accordingly, an operation to switch these coefficients may be achieved in various manners, such as using multiplexer or switching circuitry SW2 as shown in FIG. 2 and that is controlled by controller 66 in response to whether the present operation is an FFT operation or an IFFT operation. Other approaches also may be ascertained by one skilled in the art. In any event, using the same Twiddle MEM or the like, a same set of Twiddle factor coefficients is usable for both the 128-point FFT and 128 of the 256-point IFFTs.

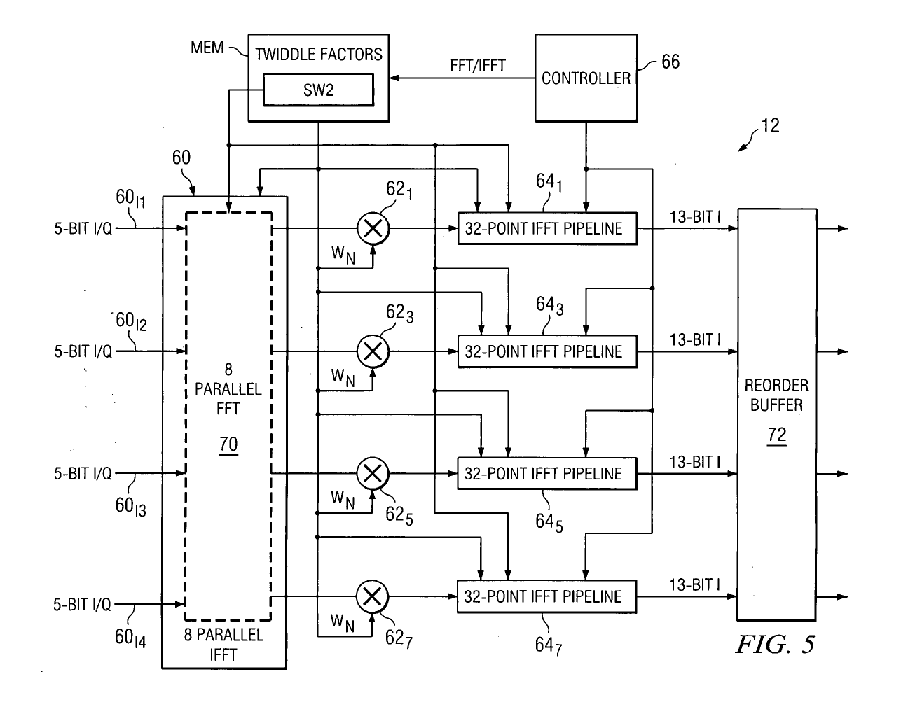

Given the preceding, FIG. 5 again illustrates integrated block 12 of FIG. 2, with a few modifications to summarize the above-discussed changes to perform an FFT with that device. First, within parallel IFFT block 60 is identified an FFT block 70 as a dashed box, where that box is shown to indicate from block 60 only the use of butterfly circuits BFFFT shown within a dashed box in FIG. 3. Only the four inputs 60_{I1} through 60_{I4} are required for the FFT operations, and those receive time samples that are not linear in order. FFT block 70 performs a two-stage parallel FFT operation on those samples, with the outputs connected to multipliers 62₁, 62₃, 62₅, and 62₇, and the output of each of those multipliers is connected, respectively, to one of pipelines 64₁, 64₃, 64₅, and 64₇. Further, controller 66 is shown to control SW2 to perform the Real and Imaginary coefficient swap function, which is shown with control lines to FFT block 70 as well as to the multipliers themselves within the blocks of integrated block 12 so that the Real and Imaginary coefficients of the input samples to FFT block 70 and resulting outputs from pipelines 64₁, 64₃, 64₅, and 64₇ may be swapped as described above. Lastly, a reorder buffer 72 receives the 13-bit Real FFT output results of pipelines 64₁, 64₃, 64₅, and 64₇ and so that those outputs may be retrieved from that buffer in time-aligned order. Concluding FIG. 5, therefore, FFT block 70 operates to perform 4 FFT operations in parallel, and the results from those four operations are passed to the serially-operating pipelines 64₁, 64₃, 64₅, and 64₇, wherein upon completing the 31 clock cycles of each pipeline those FFTs are 32-point operations; cumulatively, therefore, the outputs of pipelines 64₁, 64₃, 64₅, and 64₇ over 32 cycles provide a 128-point FFT operation based on the time domain values previously input to inputs 60_{I1} through 60_{I4}.

Also in connection with the preferred embodiments, still additional features may be implemented for a given application. Thus, below such features are described, and one skilled in the art may appreciate that while each such feature is included in this description, such features may therefore be combined into a singular preferred embodiment application or, alternatively, only a subset of one or more features may be included in different preferred embodiment applications, with the choice from these features as well as others being ascertainable by one skilled in the art.

As another possible preferred embodiment aspect, it is known in certain wireless transmission systems (e.g., OFDM) to include a cyclic prefix with each transmission of a group of symbols. Such a prefix includes a subset of the group of symbols that is copied from the group and prepended in front of the group of symbols. Various techniques and blocks are often implemented to achieve this functionality. In a preferred embodiment, however, such a prefix is incorporated into the IFFT functionality by taking advantage of the exponent of the Twiddle factor. Specifically, consider an example that requires, in addition to the group of samples consisting of the 256-point IFFT, a 64 sample prefix that is the last 64 samples in the 256-point IFFT. In other words, for IFFT samples 0,1,2,3,4, . . . 190,191,192, . . . 253,254,255, the desired sample output is to include a 64 sample prefix so that the total 320 sample output reads as follows: 192,193,194, . . . 254,255,0,1,2, . . . , 253,254,255. Thus, one implementation would be to generate the 256 IFFT samples, await and buffer the last 64 of those samples and then prepend those 64 samples to the sequence of 0,1,2,3,4, . . . , 253,254,255. Such an approach, however, requires waiting for all 256 samples as well as a 64 sample buffer. In contrast, it is recognized in connection with a preferred embodiment that in order to produce a circular shift in the time indices of 64 samples, that a shift in the time domain implies a multiplication at the input of the IFFT by e^{-j2nπ*64/N=256}=e^{-jnπ/2}; accordingly, in a preferred embodiment, to accomplish the circular shift of 64, each input sample is multiplied times e^{-jnπ/2}. With this shift, then in a preferred embodiment, only the first 64 output samples are buffered as they will correspond to samples 192, . . . 253,254,255, and then they are added to the end of the output sequence, following sample 191, to thereby provide the completion of 192, . . . 253,254,255 following the preceding outputs of 192, . . . 253,254,255, . . . 0,1,2, . . . 190, 191. Thus, there is not the need to await the last 64 samples before prepending as was suggested in the approach discussed above.

Note further that the preceding aspect may be implemented in any instance where the rotation length, RL, (e.g., 64) and the total output sample size, TOS, (e.g., 256) have an integer ratio of RL/TOS. In such a case, then the ratio is then multiplied times the exponent of e^{-j2nπ}, giving rise to e^{-j2nπ*RL/TOS}. Moreover, also in the preferred embodiment, with a multiplicand of e^{-jnπ/2}, the functional result may be achieved without an actual multiplier, but instead is more preferably implemented by recognizing that each such multiplication, depending on the value of n, gives rise to a multiplication of only one of eight combinations, that is, of ±1±j, meaning the multiplicand in any given instance is one of 1+j, 1−j, −1+j, −1−j, +1. −1, +j. −j. Thus, in the preferred embodiment, this result is achieved by a sign change of the Real and/or imaginary coefficient, based on the then-corresponding value of n.

As another possible preferred embodiment aspect, recall from Equation 1 that the IFFT operation requires the scaling factor of 1/N while from Equation 3 the FFT operation does not. Accordingly, also in the preferred embodiment the scaling is moved outside of the core architecture of block 12 so that it may be applied only to the IFFT results and not the FFT results.

As a final consideration for various possible preferred embodiment aspects, note that bit sizing for input and output for either the IFFT or FFT operations may be desired. For example, recall that FIG. 2 illustrates a 5-bit Real and Imaginary coefficient for each input 60_{I1} through 60_{I8}. If, however, the actual input is L bits less in bit number, each such input may be scaled upward by multiplying it times 2^{L}, which may be accomplished by a left shift L locations. For example, if the actual input is only a 2-bit Real and Imaginary value, then it is L=3 bits less than that expected in FIG. 2 and, hence, it may be left-shifted L=3 times to achieve a multiplication times 2³=8. Accordingly, for a given sized input, if higher precision is required, the number of bits may be increased in this manner. Also, if an output of reduced granularity is desired, such an output may be achieved by clipping and quantizing each output value to accomplish the desired size.

From the above, it may be appreciated that the preferred embodiments provide a combined IFFT and FFT circuit with various preferred embodiment aspects. In the example provided, a single core is used to achieve both IFFT and FFT operations, which is advantageous in certain applications such as in a transceiver where only the transmit path (e.g., TX_{P}) or the receive path (RX_{P}) is operable at a single time and each path requires one of either the IFFT or FFT operations. Moreover, each of the IFFT and FFT operations are achieved using a combination of P parallel operations achieved via a grid that is coupled to P serially-operating parallel pipelines that each operate to perform S transform operations independently from one another, although under common control so as to achieve proper synchronization. As a result, up to a total of an S×P-point IFFT or FFT operation may be performed. Thus, in the IFFT example given above, P=8 and S=32 for the 256-point IFFT, and for the FFT P=4 and S=32 for the 128-point FFT. However, different preferred embodiments may be derived by choosing different values of S and P, where both S and P are greater than 1 and preferably those values are adjusted for various considerations. For example, in the above-described embodiment, P could be 2 or 4, but is increased to 8 so as to avoid the need for increasing the size and complexity of the parallel grid. In addition, P could be increased if S were reduced, but doing so would increase the need for the faster circuitry that would be required to achieve all of the S serial operations in a sufficient time as dictated by the particular system application. In any event, therefore, the inventive teachings may be applied by one skilled in the art to other size operations as well and the FFT could be the larger point operation as compared to the IFFT operation, in a different embodiment. Still further, a subset of that hardware may be used such that the point-size of the IFFT differs from that of the FFT. Yet further, the two stages could be swapped so that the set of serial pipelines (e.g., 64₁ through 64₈) precedes the parallel IFFT block (e.g., block 60). As a result, various advantages and benefits have been shown with respect to the preferred embodiments. For example, a common core may be used to support both the IFFT and FFT operations, as may a single Twiddle memory and address generator for that memory. As another example, a cyclic prefix may be used with a reduced delay. Moreover, one skilled in the art may ascertain still other benefits as well. Thus, the preferred embodiments include various aspects and advantages as compared to the prior art. Accordingly, while the preferred embodiments have been shown by way of example, certain other alternatives have been provided and still others are contemplated. From the above, the preceding discussion and these examples should further demonstrate that while the present embodiments have been described in detail, various substitutions, modifications or alterations could be made to the descriptions set forth above without departing from the inventive scope which is defined by the following claims.

1. A system for determining discrete transforms as between time and frequency domains, comprising:
a grid comprising adders and multipliers, the grid operable to perform in parallel an integer number P operations of a first transform function selected from one of either an IFFT or an FFT; and
the integer number of P serially-operating pipelines, wherein each of the pipelines is coupled to the grid and is operable to perform serially over a number of cycles an integer number S operations of the first transform;
wherein S and P are both greater than one;
wherein in combination the grid and the serially-operating pipelines perform the first transform type as an S×P-point transform;
wherein in a first instance at least a portion of the grid is operable to perform IFFT operations; and
wherein in a second instance at least a portion of the grid is operable to perform FFT operations.

2. The system of claim 1:
wherein in the first instance at least a portion of the integer number of P serially-operating pipelines is operable to perform, serially over a number of cycles, the integer number S of IFFT operations; and
wherein in the second instance at least a portion of the integer number of P serially-operating pipelines is operable to perform, serially over a number of cycles, the integer number S of FFT operations.

3. The system of claim 2 wherein P equals 8 and wherein S equals 32.

4. The system of claim 3:
wherein in the first instance the at least a portion of the grid consists of all stages of the grid and the at least a portion of the integer number of P serially-operating pipelines consists of eight of the P equals 8 serially-operating pipelines; and
wherein in the second instance the at least a portion of the grid consists of two of three stages of each of the integer number P of parallel circuits and the at least a portion of the integer number of P serially-operating pipelines consists of four of the P equals 8 serially-operating pipelines.

5. The system of claim 4 and further comprising circuitry for coupling the at least a portion of the grid to the at least a portion of the integer number of P serially-operating pipelines in response to whether the transform function selected is either an IFFT or an FFT.

6. The system of claim 4:
wherein each of the integer number of P serially-operating pipelines is operable to determine a transform independently of each of the other of the P serially-operating pipelines; and
circuitry for synchronizing an output of each of the P serially-operating pipelines.

7. The system of claim 2 and further comprising circuitry for coupling the at least a portion of the grid to the at least a portion of the integer number of P serially-operating pipelines in response to whether the transform function selected is either an IFFT or an FFT.

8. The system of claim 1:
wherein each of the integer number of P serially-operating pipelines is operable to determine a transform independently of each of the other of the P serially-operating pipelines; and
circuitry for synchronizing an output of each of the P serially-operating pipelines.

9. The system of claim 1 wherein each of the integer number of P serially-operating pipelines comprises:
an integer number X of butterfly circuits; and
the integer number X of collection circuits, each coupled to a respective one of the integer number X of butterfly circuits by coupling an output from the respective butterfly circuit to the respective collection circuit and by coupling an output from the respective collection circuit to the respective butterfly circuit.

10. The system of claim 9:
wherein each collection circuit is operable to store a power of two samples; and
wherein the power of two samples stored by each collection circuit is a factor of two different than that of an adjacent stage collection circuit.

11. The system of claim 1 wherein the system is for processing a group of samples, and further comprising circuitry for combining a subset of the group of samples to the group of samples.

12. The system of claim 11 wherein the circuitry for combining a subset of the group of samples to the group of samples comprises circuitry for prepending a cyclic prefix to the group of samples.

13. The system of claim 12:
wherein the group consists of a total output sample size of TOS samples;
wherein the cyclic prefix consists of a total of RL samples; and
wherein the circuitry for prepending comprises circuitry for providing a product for selected samples in the group of samples times e^{-j2nπ*RL/TOS}.

14. The system of claim 13 wherein the circuitry for providing a product comprises circuitry for selectively changing a sign of either or both of a Real and an Imaginary coefficient of each selected samples.

15. The system of claim 1 wherein each of the samples for which a transform is to be determined comprises a binary value, and further comprising circuitry for increasing precision of the binary value by determining a product of each binary value times a power of two.

16. The system of claim 1 wherein the grid and the integer number of P serially-operating pipelines are a part of an orthogonal frequency division multiplexing system.

17. The system of claim 1 wherein the grid and the integer number of P serially-operating pipelines are a part of a digital subscriber line system.

18. The system of claim 1 wherein the grid precedes the integer number of P serially-operating pipelines such that each of the pipelines is coupled to receive an output from the grid.

19. The system of claim 1 wherein the grid follows the integer number of P serially-operating pipelines such that an output of each of the pipelines is coupled to provide an input to the grid.

20. The system of claim 1 and further comprising circuitry for swapping, in response to a transition between the first instance and the second instance, a Real coefficient with an Imaginary coefficient for each sample input to the system and for each transformed sample output from the system.

21. A system for determining discrete transforms as between time and frequency domains, comprising:
a grid comprising adders and multipliers, the grid operable to perform in parallel an integer number P operations of a first transform function selected from one of either an IFFT or an FFT; and
the integer number of P serially-operating pipelines, wherein each of the pipelines is coupled to the grid and is operable to perform serially over a number of cycles an integer number S operations of the first transform;
wherein S and P are both greater than one;
wherein in combination the grid and the serially-operating pipelines perform the first transform type as an S×P-point transform;
wherein in a first instance at least a portion of the grid is operable to perform IFFT operations;
wherein in a second instance at least a portion of the grid is operable to perform FFT operations;
wherein in the first instance at least a portion of the integer number of P serially-operating pipelines is operable to perform, serially over a number of cycles, the integer number S of IFFT operations; and
wherein in the second instance at least a portion of the integer number of P serially-operating pipelines is operable to perform, serially over a number of cycles, the integer number S of FFT operations; and
wherein each of the integer number of P serially-operating pipelines comprises:
an integer number X of butterfly circuits; and
the integer number X of collection circuits, each coupled to a respective one of the integer number X of butterfly circuits by coupling an output from the respective butterfly circuit to the respective collection circuit and by coupling an output from the respective collection circuit to the respective butterfly circuit; and
further comprising circuitry for swapping, in response to a transition between the first instance and the second instance, a Real coefficient with an Imaginary coefficient for each sample input to the system and for each transformed sample output from the system.

22. A method of determining discrete transforms as between time and frequency domains, comprising:
operating, in a first instance, at least a portion of a grid comprising adders and multipliers, to perform in parallel an integer number P operations of a first transform function selected from one of either an IFFT or an FFT; and
operating in the first instance, at least a portion of the integer number of P serially-operating pipelines wherein each of the pipelines is coupled to the grid, to perform serially over a number of cycles an integer number S operations of the first transform;
wherein S and P are both greater than one;
wherein in combination the grid and the serially-operating pipelines perform the first transform type as an S×P-point transform.
wherein in the first instance the operating step comprises operating at least a portion of the grid is operable to perform IFFT operations; and
further comprising:
operating, in a second instance, at least a portion of the grid to perform in parallel a number of FFT operations; and
operating in the second instance, at least a portion of the integer number of P serially-operating pipelines to perform serially over a number of cycles an integer number S of FFT operations.

23. The method of claim 22 and further comprising coupling the at least a portion of the grid to the at least a portion of the integer number of P serially-operating pipelines in response to whether the transform function selected is either an IFFT or an FFT.

24. The method of claim 22:
wherein each of the integer number of P serially-operating pipelines is operable to determine a transform independently of each of the other of the P serially-operating pipelines; and
synchronizing an output of each of the P serially-operating pipelines.

25. The method of claim 22 wherein each of the integer number of P serially-operating pipelines comprises:
an integer number X of butterfly circuits; and
the integer number X of collection circuits, each coupled to a respective one of the integer number X of butterfly circuits by coupling an output from the respective butterfly circuit to the respective collection circuit and by coupling an output from the respective collection circuit to the respective butterfly circuit.

26. The method of claim 22 wherein the system is for processing a group of samples, and further comprising combining a subset of the group of samples to the group of samples.

27. The method of claim 26 wherein the step of combining a subset of the group of samples to the group of samples comprises prepending a cyclic prefix to the group of samples.

28. The method of claim 27:
wherein the group consists of a total output sample size of TOS samples;
wherein the cyclic prefix consists of a total of RL samples; and
wherein the step of prepending comprises providing a product for selected samples in the group of samples times e^{-j2nπ*RL/TOS}.

29. The method of claim 28 wherein the step of providing a product comprises selectively changing a sign of either or both of a Real and an Imaginary coefficient of each selected samples.

30. The method of claim 22 wherein each of the samples for which a transform is to be determined comprises a binary value, and further comprising increasing precision of the binary value by determining a product of each binary value times a power of two.

31. The method of claim 22 wherein the grid and the integer number of P serially-operating pipelines are a part of an orthogonal frequency division multiplexing system.

32. The method of claim 22 wherein the grid and the integer number of P serially-operating pipelines are a part of an digital subscriber line system.

33. The system of claim 22 wherein the grid precedes the integer number of P serially-operating pipelines such that each of the pipelines is coupled to receive an output from the grid.

34. The method of claim 22 wherein the grid follows the integer number of P serially-operating pipelines such that an output of each of the pipelines is coupled to provide an input to the grid.

35. The method of claim 22 and further comprising swapping, in response to a transition between the first instance and the second instance, a Real coefficient with an Imaginary coefficient for each sample input to the system and for each transformed sample output from the system.
